(19) United States
(12) Patent Application Publication
(10) Pub. No.: US 2024/0386581 A1
(43) Pub. Date: Nov. 21, 2024

(54) TRACKING SYSTEM FOR MOVING BODY

(71) Applicant: TOYOTA JIDOSHA KABUSHIKI KAISHA, Aichi-ken (JP)

(72) Inventors: Hitoshi KAMADA, Kawasaki-shi (JP); Hsuan-Kung YANG, Sumida-ku (JP); Norimasa KOBORI, Nakano-ku (JP); Naphatthara PHLOYNGAM, Minato-ku (JP); Mustafa ERDOGAN, Taito-ku (JP); Rajat SAINI, Edogawa-ku (JP); Quan KONG, Toshima-ku (JP)

(21) Appl. No.: 18/611,698

(22) Filed: Mar. 21, 2024

(30) Foreign Application Priority Data
May 19, 2023 (JP) 2023-083394

(51) Int. Cl. G06T 7/292; G06T 7/246

(52) U.S. Cl. CPC G06T 7/292; G06T 7/246; G06T 2207/10016; G06T 2207/20072

(57) ABSTRACT

A tracking system for moving body includes a graph. In the graph, a node representing a single camera and a node representing a common tracking ID assigned to a moving body reflected in image data acquired by a single camera are connected via an edge. In the graph, further, nodes representing respective single cameras are connected via at least one edge representing a relationship between the at least two single cameras if there is a relationship between the at least two single cameras. In the graph, furthermore, nodes representing the at least two common tracking IDs are connected via at least one edge representing that the at least two moving bodies reflected in each video data captured by the at least two single cameras are the same moving object if the nodes representing the at least two common tracking IDs are recognized to be the same moving object.

### CROSS-REFERENCE TO RELATED APPLICATION

The present application claims priority under 35 U.S.C. § 119 to Japanese Patent Application No. 2023-083394, filed on May 19, 2023, the contents of which application are incorporated herein by reference in their entirety.

### TECHNICAL FIELD

The present disclosure relates to a system that uses image data acquired by a plurality of cameras to track a moving body reflected in the image data.

### BACKGROUND

JP2017021753A discloses an art that uses image data acquired by a plurality of cameras to graph a person image reflected in the image data. In this related art, a frame (an image) in which a person is detected is extracted from the frame included in the image data.

Subsequently, a rectangle area (i.e., a bounding box) including the detected person is trimmed from this extracted frame. The extraction of the frame in which the person are detected and the trimming of the bounding box are performed for a plurality of frames that differ in at least one of shooting time and location. Therefore, the number of the bounding boxes to be extracted is also plural.

In the related art, an image sequence consisting of five bounding boxes is then extracted from among the plurality of the extracted bounding boxes with reference to Euclidean distance between the plurality of cameras. Subsequently, a similarity of person images is calculated based on a feature quantity of the person images included in the image sequence. This similarity is used to determine whether the person images included in the five bounding boxes are the same person.

In the related art, when it is determined that the person images included in the five bounding boxes are the same person, a graph is generated for the five bounding boxes. This graph is expressed by using nodes (vertexes, node points) and edges (edges, branches) in a graph theory. In FIGS. 7-9 of the related art, an example of the graph in which five bounding boxes (person images) are designated as nodes and connected via edges. The five bounding boxes were determined to be the same person through data processing on image data that were acquired by multiple cameras installed at different locations.

JP2022086650A discloses an art for dividing image data from a surveillance camera into predetermined time widths and generating a graph from the image data for each divided time width. In this related art, the graph includes a node graph and an edge graph. The node graph includes a unique node ID assigned to a monitored element reflected in the image data of the surveillance camera, and tracking information and attribute information of the element linked to this node ID. When the monitored element includes two persons, the edge graph includes information on interaction actions of the persons. When the monitored element includes a person and an object, the edge graph includes information on relationships between the person and the object.

In the related art of JP2022086650A, the generated graph is also stored in a database. The node graph is stored in the databases for node, and the edge graph is stored in the databases for edge. In other words, the generated node and edge graphs are stored in separate databases.

Consider a case of tracking a moving body (a person, a robot, a vehicle, etc.) reflected in image data captured by multiple cameras. According to the related art of JP2017021753A, the graph is generated for the same person reflected in the image data. Therefore, using this graph, it is possible to track the same moving object reflected in the image data. However, in the related art, the image sequences are extracted based on Euclidean distance, so this extraction cannot be performed between cameras with large Euclidean distance. Therefore, the graph generated by the related art is unsuitable for tracking the moving body moving over a wide range.

Furthermore, JP2022086650A describes generating a graph for a single surveillance camera, but does not describe multiple surveillance cameras. Even if graphs were generated for multiple surveillance cameras, relationship between these graphs would not be defined. There is a high possibility that node and edge graphs generated for each surveillance camera would be stored in separate databases. Therefore, the related art of JP2022086650A cannot track the same moving object reflected in the image data captured by multiple cameras.

An objective of the present disclosure is to provide a technique that can track the same moving object reflected in image data acquired by a plurality of cameras arranged over a wide area.

### SUMMARY

An aspect of the present disclosure is a tracking system for a moving body and has the following features.

The tracking system includes a memory device and a processor. The memory device stores video data acquired by at least two cameras. The processor is configured to perform data processing based on each video data acquired by the at least two cameras.

In the data processing, the processor generates a graph consisting of at least two nodes and at least one edge indicating a relationship between the at least two nodes, and stores the generated graph in the memory device.

In the generated graph, a node representing a single camera included in the at least two cameras, and a node representing a tracking identification number (tracking ID) assigned to a moving body reflected in the image data acquired by the single camera are connected via at least one edge. The tracking identification number includes a common tracking identification number (a common tracking ID) assigned to the same moving object reflected in the image data acquired by the single camera.

In the generated graph, nodes representing respective single cameras are connected via at least one edge representing a relationship between the at least two single cameras if there is a relationship between the at least two single cameras.

In the generated graph, nodes representing the at least two common tracking identification numbers are connected via at least one edge representing that the at least two moving bodies reflected in each video data captured by the at least two single cameras are the same moving object if the nodes representing the at least two common tracking identification numbers are recognized to be the same moving object.

According to the present disclosure, the graph composed of at least two nodes and at least one edge representing the relationship between the at least two nodes is generated and stored in the database in the memory device. In this generated graph, the node representing the single cameras and the node representing the tracking identification number assigned to the moving body reflected in the image data acquired by the same single camera are connected via at least one edge. Furthermore, this tracking identification number includes the common tracking identification number assigned to the same moving object reflected in the image data acquired by the single camera.

In this generated graph, further, the nodes representing respective single cameras are connected via at least one edge representing a relationship between the at least two single cameras if there is a relationship between the at least two single cameras. In this graph, furthermore, nodes representing the at least two common tracking identification numbers are connected via at least one edge representing that the at least two moving bodies reflected in each video data captured by the at least two single cameras are the same moving object if the nodes representing the at least two common tracking identification numbers are recognized to be the same moving object.

Therefore, by using such the generated graph, it is possible to track the same moving object reflected in the image data obtained from at least two single cameras. This effect is expected to be obtained even when many cameras are placed over a wide area.

### BRIEF DESCRIPTION OF DRAWINGS

FIG. 1 is a diagram for illustrating an example overall configuration of a tracking system related to an embodiment;

FIG. 2 is a diagram for illustrating detection processing of a person and re-identification processing of the person performed by a graph generation processing portion;

FIG. 3 is a diagram showing a basic configuration example of a graph generated by the graph generation processing portion;

FIG. 4 is a diagram showing a detailed configuration example of the graph generated by the graph generation processing portion;

FIG. 5 is a diagram for illustrating an example of verification processing performed by a graph verification processing portion;

FIG. 6 is a diagram for illustrating an example of verification processing performed by graph verification processing portion;

FIG. 7 is a diagram for illustrating an example of verification processing performed by graph verification processing portion;

FIG. 8 is a diagram for illustrating an example of verification processing performed by graph verification processing portion;

FIG. 9 is a diagram for illustrating an example of tracking processing performed by tracking processing portion; and

FIG. 10 is a diagram for illustrating an example of tracking processing performed by tracking processing portion.

### DESCRIPTION OF EMBODIMENT

An embodiment of the present disclosure will be described below with reference to the drawings. In each Figure, the same or corresponding parts are given the same sign and the explanation thereof will be simplified or omitted.

### 1. Overall Configuration Example

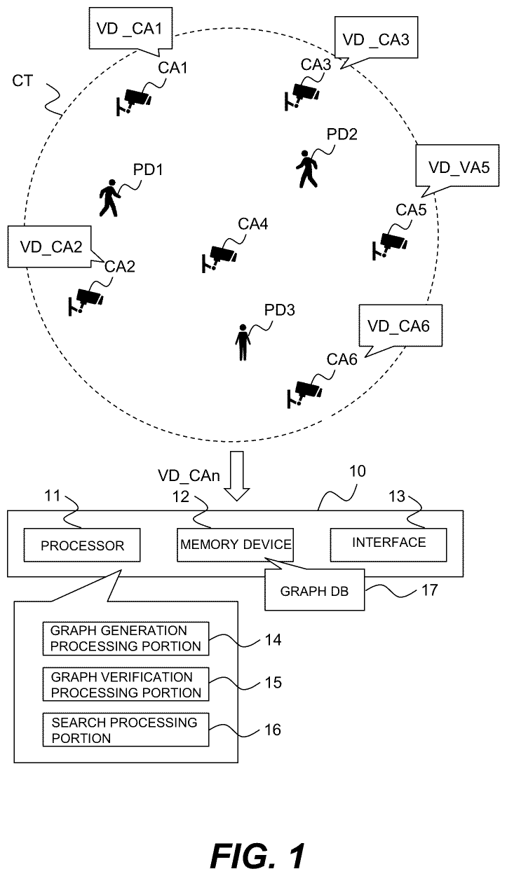

FIG. 1 is a diagram for illustrating an overall configuration example of a tracking system (hereinafter also simply referred to as a “system”) related to the embodiment. The system related to the embodiment is a system for tracking a moving body moving inside an urban CT. There is no limit to the scale of the city CT in this disclosure. A so-called smart city is an example of a large-scale urban CT, an underground mall is an example of a medium-sized urban CT, and a large building is an example of a small-scale urban CT. Examples of moving bodies include persons, robots, and vehicles. In embodiment, the moving body is a person (a pedestrian PD). Walker PD1-PD3 are depicted in FIG. 1 as an example of the pedestrian PD.

The system according to embodiment includes at least two cameras placed in the city CT. FIG. 1 shows cameras CA1-CA6 as an example of at least two cameras. The camera CA1 acquires image data VD_CA1. Similar to camera CA1, the cameras CA2-CA6 acquire image data VD_CA2-VD_CA6, respectively. Image data VD_CAn of any one camera CAn (n is a natural number) placed in the city CT is transmitted to the management server 10 via the communication line network. Note that the communication line network is not particularly limited, and wired and wireless networks can be used.

The management server 10 is a computer including at least one processor 11, at least one memory device 12, and at least one interface 13. The processor 11 performs various data processing. The processor 11 includes a CPU (Central Processing Unit). The memory device 12 stores various data necessary for data processing. Examples of the memory device 12 include an HDD, an SSD, a volatile memory, and a nonvolatile memory.

The interface 13 receives various data from an outside and also outputs various data to the outside. The various data that the interface 13 receives from the outside includes image data VD_CAn. This image data VD_CAn is stored in the memory device 12. A graph DB (database) 17 is formed in the memory device 12. The graph DB 17 may be formed in an external device that can communicate with the management server 10.

### 2. Configuration Example of Management Server

FIG. 1 shows an example function configuration of the management server 10. In the example shown in FIG. 1, the management server 10 includes a graph generation processing portion 14, a graph verification processing portion 15, and a tracking processing portion 16. Note that these functions are realized by the processor 11 executing various programs stored in the memory device 12.

### 2-1. Graph Generation Processing Portion

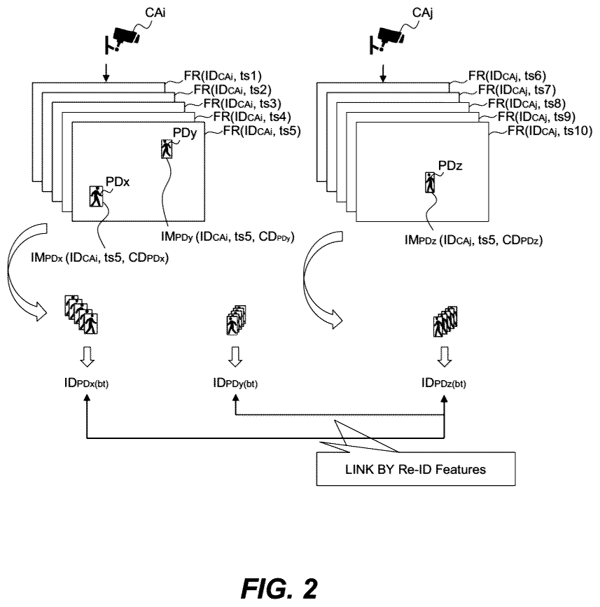

The graph generation processing portion 14 performs processing to generate a graph GPH based on the image data VD_CAn. In order to generate the graph GPH, the graph generation portion processing 14 performs person detection and extraction processing and person re-identification processing. FIG. 2 is a diagram for illustrating person detection processing and person re-identification processing performed by the graph generation processing portion 14.

FIG. 2 depicts image data VD_CAi of a camera CAi and image data VD_CAj of a camera CAj as examples of the image data VD_CAn. The image data VD_CAi and VD_CAj are each separated by a predetermined time width, and FIG. 2 depicts a set of frames FR at interval time bt. Each frame FR of the image data VD_CAi includes, for example, data of ID_{CAi} of the camera CAi and data of time stamp ts (e.g., frame acquisition time). Like each frame FR of the image data VD_CAi, each frame FR of the image data VD_CAj also includes data of ID_{CAj} of the camera CAj and data of time stamp ts.

In the detection and extraction processing, first, a frame FR in which a person is detected is extracted. Subsequently, the detected person is extracted from this extracted frame. In the example shown in FIG. 2, pedestrians PDx and PDy are detected in each frame within interval time bt1 (time stamps ts1-ts5) of the image data VD_CAi.

Furthermore, pedestrian PDz is detected in each frame within interval time bt2 (time stamps ts6-ts10) of the image data VD_CAj. A bounding box surrounding these pedestrians PD is assigned to each position where pedestrians PDx, PDy, and PDz are detected. By trimming this bounding box, images IM_{PDx}, IM_{PDy}, and IM_{PDz} of pedestrians PDx, PDy, and PDz are extracted, respectively. Images IM_{PDx} and IM_{PDy} of the pedestrian PD include, for example, data of ID_{CAi} of the camera CAi, data of the time stamp ts, and data of coordinate CD_{PD} in the frame FR of the extracted image.

In the re-identification processing, feature quantities for re-identification processing (hereinafter also referred to as “Re-ID feature quantities”) are extracted from each image IMPD extracted in the detection and extraction processing. Extraction of the Re-ID feature quantity is performed using a Re-ID model based on machine learning. Note that the technique for extracting the Re-ID feature quantity using the Re-ID model is well known, and the technique is not particularly limited. Once the Re-ID feature quantity is extracted from each image IMPD, it is determined whether the person included in the image sequence is the same person by comparing the Re-ID feature quantities.

In the example shown in FIG. 2, the Re-ID feature quantities of persons extracted from each image IM_{PD} in interval time bt1 are similar, so the pedestrians PDx and PDy included in the image sequence in interval time bt1 are determined to be the same person. In addition, since the Re-ID feature quantities of the persons extracted from each image IM_{PD} in interval time bt2 are similar, it is determined that pedestrian PDz included in the image sequence in interval time bt2 is the same person.

When the detection processing is performed, a tracking ID_{PD} is assigned to the person reflected in the image data VD_CAn. Among these tracking ID_{PD}S, a person who is determined to be the same person through the re-identification processing is given a tracking ID_{PD} common to this person (hereinafter also referred to as a “common tracking ID_{PD}”). The common tracking ID_{PD} is also referred to as a universal unique ID (UUID). In the example shown in FIG. 2, common tracking ID_{PDx(bt1)}, ID_{PDy(bt1)}, and ID_{PDz(bt2)} are assigned to the pedestrians PDx, PDy, and PDz. Each common tracking IDPD combines data of the interval time bt with data representing the data of Re-ID feature quantity extracted from the image sequence of this interval time bt. Note that the example of selecting representative data of the Re-ID feature quantity is not particularly limited, and any method can be adopted.

The common tracking ID_{PD} is generated every interval time bt. Therefore, if the same pedestrian PD continues to be captured by a single camera, common tracking ID_{PD} assigned to this pedestrian PD may be generated separately by the number of interval times bt.

Therefore, in the re-identification processing, the Re-ID feature quantity may be compared between a plurality of different image sequences at interval time bt. For example, the Re-ID feature quantity is compared between two image sequences of interval time bt with close time stamps ts. If the Re-ID feature quantity is similar between multiple image sequences, it is determined that each pedestrian PD included in these image sequences is the same person and the respective Re-ID feature quantities that were assigned to each pedestrian PD separately may be integrated into one.

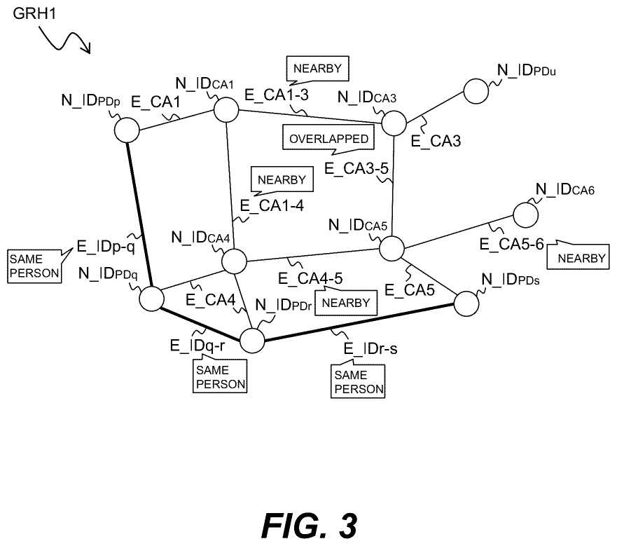

The graph generation processing portion 14 generates the graph GRH based on the common tracking ID_{PD} assigned to the pedestrian PD by the above-described re-identification processing and each ID of at least two cameras placed in the city CT. The generated graph GRH is stored in the graph DB 17. As already explained, the graph GRH is expressed using nodes (vertexes, node points) and edges (edges, branches) in the graph theory. FIG. 3 is a diagram showing a basic configuration example of the graph GRH generated by the graph generation processing portion 14. FIG. 3 is a graph GRH1 that includes nodes N_ID_{CA1}-N_ID_{CA6}, which represent respective IDs of the cameras CA1-CA6 (however, CA2 is omitted) shown in FIG. 1, and edge E, which represents the relationship between these nodes.

Here, an installation position of the camera CA1 is close to that of the camera CA3.

Therefore, there is a relationship between these cameras. Therefore, in the graph GRH1 shown in FIG. 3, node N_ID_{CA1} representing the ID of the camera CA1 and node N_ID_{CA3} representing the ID of the camera CA3 are connected via edge E_CA1-3. The meaning of this edge E_CA1-3 is “nearby”. “NEARBY” relationships also exist between the camera CA1 and the camera CA4, between the camera CA4 and the camera CA5, and between the camera CA5 and the camera CA6. Therefore, node N representing each ID of two cameras CA having a relationship is connected via one edge E (an edge E_CA1-4, an edge E_CA4-5, and an edge E_CA5-6).

Another example of a relationship between two camera CAs is that some or all of the imaging ranges of these cameras overlap. Here, part of the imaging range of the camera CA3 and that of the camera CA5 overlap. Therefore, in the graph GRH1 shown in FIG. 3, node N_ID_{CA3} representing the ID of the camera CA3 and node N_ID_{CA5} representing the ID of the camera CA5 are connected via edge E_CA3-5. The meaning of this edge E_CA3-5 is “OVERLAPPED”.

The node N_ID_{PD} representing the common tracking ID_{PD} assigned to the pedestrian PD is connected via at least one edge E to the node N_ID_{CAn} representing the camera CAn that acquired the image data VD_CAn from which this common tracking ID_{PD} was assigned. tied together. FIG. 3 depicts nodes N_ID_{PDp}, N_ID_{PDq}, N_ID_{PDr}, N_ID_{PDs}, and N_ID_{PDu}, which represent common tracking ID_{PDs} assigned to pedestrians PDp, PDq, PDr, PDs, and PDu, respectively. The node N_ID_{PD}p is connected to node N_ID_{CA1} via the edge E_CA1. The nodes N_ID_{PDq} and N_ID_{PDr} are each connected to node N_ID_{CA4} via two edges E_CA4. The node N_ID_{PDs} is connected to node N_ID_{CA5} via edge E_CA5, and the node N_ID_{PD}u is connected to node N_ID_{CA3} via edge E_CA3.

As already explained, the common tracking ID_{PD} includes a combination of interval time bt data and representative data of the Re-ID feature quantity in the image sequence. In the embodiment, the re-identification processing of the person seen in at least two cameras is performed using representative data of the Re-ID feature quantity. In this re-identification processing, the same processing as the comparison of Re-ID feature quantity performed between a plurality of different image sequences at interval time bt is performed. Although the target of the comparison of the Re-ID feature quantity is one camera, the target of the comparison of Re-ID feature quantity is two cameras in the re-identification processing. If the representative data of the Re-ID feature quantity is similar between the two cameras, it is determined that the pedestrian PDs separately seen by these cameras are the same person.

In the graph generation processing portion 14, when it is determined that the pedestrian PDs separately seen by two cameras are the same person, the node N_ID_{PD} representing the common tracking ID_{PD} separately assigned to these pedestrian PDs is connected via the edge E. In the graph GRH1 shown in FIG. 3, pedestrians PDp and PDq are determined to be the same person, and pedestrians PDr and PDs are determined to be the same person. Therefore, the node N_ID_{PD}p and the node N_ID_{PDq} are connected via the edge E_IDp-q, and the node N_ID_{PDr} and the node N_ID_{PDs} are connected via the edge E_IDr-s. The meanings of the edges E_IDp-q and E_IDr-s are “same person”.

In the graph GRH1 shown in FIG. 3, it is also determined that pedestrian PDq and PDr are the same person. This determination is based on the results of a comparison of the Re-ID feature quantity between a plurality of image sequences that differ in interval time bt, which is performed for one camera. For this reason, the node N_ID_{PDq} and the node N_ID_{PDr} are connected via edge E_IDqr, which means “same person (SAME PERSON).”

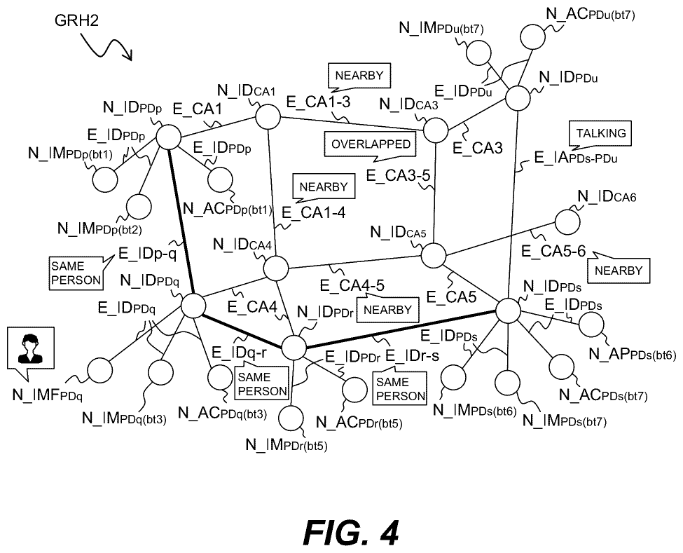

FIG. 4 is a diagram showing a detailed configuration example of a graph generated by the graph generation processing portion 14. In the graph GRH2 shown in FIG. 4, a node N representing additional information ADD is added to the graph GRH1 shown in FIG. 3.

This additional information ADD is for a pedestrian PD to which a common tracking ID_{PD} is assigned. Examples of additional information ADD include an image IM_{PD} of pedestrian PD, an appearance feature AP_{PD} of pedestrian PD, an action AC_{PD} of pedestrian PD, and face image IMF_{PD} of pedestrian PD.

The image IM_{PD} of pedestrian PD was used to extract Re-ID feature quantity.

Examples of the pedestrian PD's appearance features include the pedestrian PD's color, clothing, and body shape. This appearance feature is estimated using a previously learned appearance model. In addition to “walking”, examples of the pedestrian PD's action include “carry” and “opening” performed by the pedestrian PD on a stationary body such as a baggage. This action is estimated using an action model learned in advance. This action also includes interaction actions such as “talking” and “delivery” performed by multiple persons together. The face image IMF_{PD} of the pedestrian PD may be a face image obtained by trimming the face part from the image IM_{PD} of the pedestrian PD, or may be a face image provided externally in tracking processing by tracking processing portion 16 (described later).

In the graph GRH2 shown in FIG. 4, beyond the three edges E_ID_{PDp} extending from node N_ID_{PDp}, nodes N_IM_{PDp(bt1)} and N_IM_{PDp(bt2)} representing image IM_{PDp} of the pedestrian PDp, and node N_AC_{PDp(bt1)} representing action of the pedestrian PDp are located. In addition, beyond the three edges E_ID_{PDq} extending from node N_ID_{PDq}, node N_IMF_{PDq} representing face image IMF_{PDq} of pedestrian PDq, node N_IM_{PDq(bt3)} representing image IM_{PDq} of pedestrian PDq, and node N_AC_{PDq(bt3)} representing action of pedestrian PDq are located.

Although a detailed explanation will be omitted, in the graph GRH2, node N representing additional information ADD for each pedestrian PD is connected to node N_ID_{PD} via edge E for nodes N_ID_{PDr}, N_ID_{PDs}, and N_ID_{PDu}. Note that node N_ID_{PDs} and node N_ID_{PDu} are connected via edge E_IA_{PDs-PDu}, which means interaction action “talking”. Further, node N_AP_{PDs(bt6)} connected to node N_ID_{PDs} via edge E_ID_{PDs} represents appearance feature AP_{PDs} of pedestrian PDs at interval time bt6.

### 2-2. Graph Verification Processing Portion

The graph verification processing portion 15 verifies the determination made in the graph generation portion processing 14, specifically, the determination made using the representative data of Re-ID feature quantity. According to the judgment using the representative data of Re-ID feature quantity, a certain degree of certainty can be obtained that the pedestrian PD seen separately by the two cameras is the same person. However, if the positional relationship between the two cameras and the temporal or spatial positional relationship of the pedestrian PD determined to be the same person are taken into account, the determination results may be inconsistent. The graph verification processing portion 15 detects this discrepancy. If it is determined that there is a contradiction, edge E, which means “same person (SAME PERSON)”, is deleted. In other words, the connection between the two nodes N_ID_{PD} based on the representative data of Re-ID feature quantity is released.

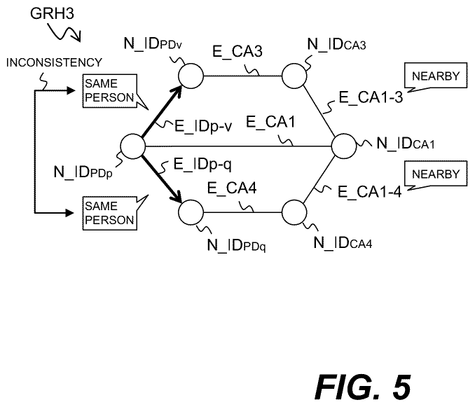

FIGS. 5-8 is a diagram for illustrating an example of verification processing performed by graph verification processing portion 15. The verification processing is performed using graph GRH. Each of the graphs GRH3-6 shown in FIGS. 5-8 includes a node N_ID_{CA} representing each ID of at least two cameras, and an edge E representing the relationship between these nodes. Furthermore, nodes N_ID_{PD} representing common tracking ID_{PD} are connected to at least two nodes N_ID_{CA} via edge E, respectively.

In graph GRH3 shown in FIG. 5, node N_ID_{PDp} connected to node N_ID_{CA1} via edge E_CA1 and node N_ID_{PDq} connected to node N_ID_{CA4} via edge E_CA4 mean “same person”. Connected via edge E_IDp-q. The node N_ID_{PDp} is also connected to node N_ID_{PDv}, which is connected to node N_ID_{CA3} via edge E_CA3, via edge E_IDp-v, which means “same person (SAME PERSON).”

However, considering the positional relationship of the cameras CA1, CA3, and CA4 and the movement direction of pedestrian PDp predicted based on interval time bt (arrow direction of edge E_IDp-q and E_IDp-v), the simultaneous existence of edges E_IDp-q and E_IDp-v is contradictory. This is because the graph GRH3 has a connection as if one pedestrian PDp had been split into two pedestrians PDq and PDv. Therefore, in this case, edges E_IDp-q and E_IDp-v are deleted. In an advanced example, node N_ID_{PD} representing a pedestrian PD determined to be the same person as pedestrian PDp and the predicted movement direction of pedestrian PDp are further considered. In this case, the inappropriate edge E can be deleted, and the appropriate edge E can be left.

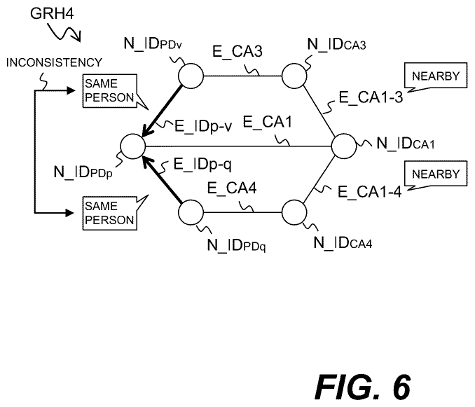

The structure of graph GRH4 shown in FIG. 6 is basically the same as that of graph GRH3 shown in FIG. 5. The difference between these graphs lies in the movement direction of pedestrian PDp (the direction of the arrow of edge E_IDp-q and E_IDp-v) predicted based on interval time bt. However, the verification results are the same. This is because the graph GRH3 has a connection as if two pedestrians PDq and PDv were fused into one pedestrian PDp. Therefore, in this case as well, edges E_IDp-q and E_IDp-v are deleted.

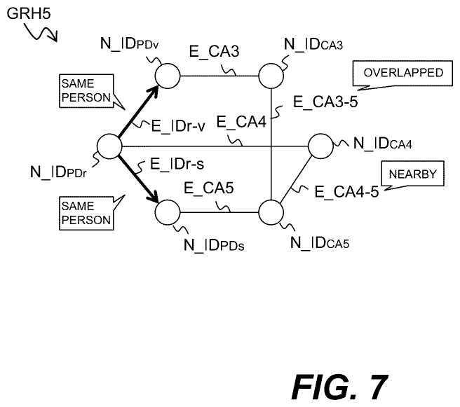

In graph GRH5 shown in FIG. 7, the node N_ID_{PDr} connected to the node N_ID_{CA4} via the edge E_CA4. The node N_ID_{PDr} also connected to the node N_ID_{CA5}, which is connected via the edge E_CA5, via the edge E_IDr-s that means “same person (SAME PERSON)”. The node N_ID_{PDr} is also connected to the node N_ID_{PDv} via the edge E_IDr-v, which means “same person (SAME PERSON).”

Unlike the verification results described with reference to FIGS. 5 and 6, the verification results based on graph GRH5 shown in FIG. 7 are “consistent.” The reason for this is that node N_ID_{CA5} and node N_ID_{CA3} are connected via edge E_CA3-5, which means “overlap”. As a result, one pedestrian PDr appears to have split into two pedestrian PDs and PDv, but the verification results show that there is no contradiction in the fact that pedestrian PDs and PDv are the same person.

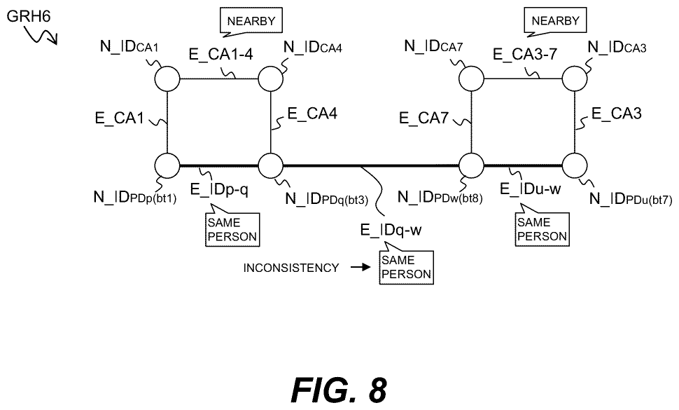

In graph GRH6 shown in FIG. 8, the node N_ID_{PDp(bt1)} and the node N_ID_{PDq(bt3)} are connected via the edge E_IDp-q, which means “same person”. In graph GRH6, the node N_ID_{PDu (bt7)} connected to the node N_ID_{CA3} via the edge E_CA3. The node N_ID_{PDu (bt7)} also connected to the node N_ID_{PDw(bt8)}, which is connected to the node N_ID_{CA7} via the edge E_CA7, via the edge E_IDu-w that means “same person (SAME PERSON)”.

In graph GRH6, node N_ID_{PDq (bt3)} and node N_ID_{PDw(bt8)} are further connected via edge E_IDq-w, which means “same person (SAME PERSON).” However, considering that there is no relationship between the positions of cameras CA4 and CA7 (i.e., there is no edge E between nodes N_ID_{CA4} and node N_ID_{CA7}) and the distance between cameras CA4 and CA7, edge E_IDu-w is It is determined that there is a contradiction in its existence. In this case, edge E_IDu-w is deleted.

### 2-3. Tracking Processing Portion

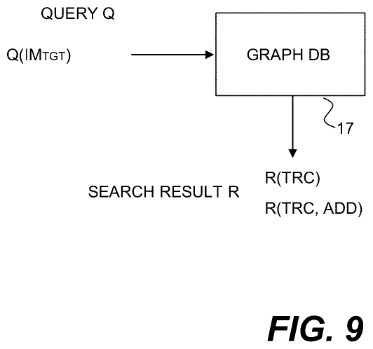

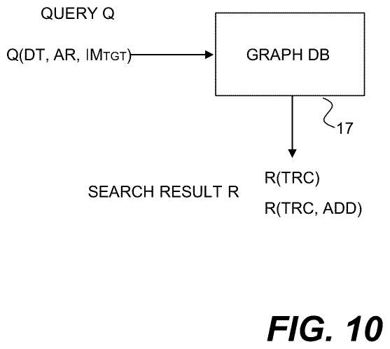

The tracking processing portion 16 uses the graph GPH stored in the graph DB 17 to track the tracking target. FIGS. 9 and 10 are diagrams for illustrating examples of tracking processing performed by tracking processing portion 16. In the example shown in FIG. 9, the graph DB 17 is referenced using the tracking target image IM_{TGT} as the query Q (input information). The image IM_{TGT} is selected, for example, from the frame of the pedestrian PD used to extract the Re-ID feature quantity. The image IM_{TGT} may be the face image IMF_{TGT} of the tracking target. The face image IMF_{TGT} in this case may be one trimmed from the frame of the pedestrian PD used to extract the Re-ID feature quantity, or may be one provided from outside the tracking system.

In the example shown in FIG. 9, the tracking data TRC of the pedestrian PD whose image IM_{TGT} and its image IM_{PD} match is output as the search result R. The tracking data TRC includes, for example, a set of nodes N_IM_{PD} representing image IM_{PD} that matches image IM_{TGT}, a set of nodes N_ID_{PD} connected to each node N_IM_{PD} via edge E, and a set of nodes N_ID_{CAs} connected to each node N_ID_{PD} via edge E. In another example, a set of nodes N representing additional information ADD (i.e., the appearance feature AP_{PD}, the action AC_{PD}, etc.) connected to each node N_IM_{PD} via edge E is further added to the tracking data TRC.

In the example shown in FIG. 10, the graph DB 17 is referenced using the date and time DT, location AR, and image IM_{TGT} as query Q (input information). In this example as well, the tracking data TRC of the pedestrian PD whose image IM_{TGT} and its image IM_{PD} match is output as the search result R. However, in the example shown in FIG. 10, since the date and time DT and location AR are included in the query Q, tracking data TRC with limited date/time and location will be output.

### 3. Effect

According to the embodiment described above, a graph GRH in which nodes N_ID_{PD} representing two common tracking ID_{PD}s are connected via edge E is generated based on image data VD_CA obtained from at least two cameras. Therefore, by tracking processing using this graph GRH, it becomes possible to track the same person (same moving object) reflected in these image data VD_CA. This effect is also expected to be obtained when many cameras are placed over a wide area.

Also, according to the embodiment, the connection between node N_ID_{PD} representing two common tracking ID_{PD}s is verified. Then, if it is determined that there is a contradiction in the results of the determination made at the time of linking, this link is canceled. It is expected that such verification will lead to ensuring the reliability of graph GRH.

Furthermore, the generation of the graph GRH and the verification of the connections described above can be performed in parallel with the acquisition of image data VD_CA. Therefore, it is possible to track the same person reflected in the image data VD_CA in real time and with high precision.

What is claimed is:

1. A tracking system for a moving body, comprising:
a memory device in which video data acquired by at least two cameras is stored; and
a processor configured to perform data processing based on each video data acquired by the at least two cameras,
wherein, in the data processing, the processor is configured to:
generate a graph consisting of at least two nodes and at least one edge indicating a relationship between the at least two nodes; and
stores the generated graph in the memory device,
wherein, in the generated graph, a node representing a single camera included in the at least two cameras, and a node representing a tracking identification number assigned to a moving body reflected in the image data acquired by the single camera are connected via at least one edge,
wherein the tracking identification number includes a common tracking identification number assigned to the same moving object reflected in the image data acquired by the single camera,
wherein, in the generated graph, nodes representing respective single cameras are connected via at least one edge representing a relationship between the at least two single cameras if there is a relationship between the at least two single cameras,
wherein, in the generated graph, nodes representing the at least two common tracking identification numbers are connected via at least one edge representing that the at least two moving bodies reflected in each video data captured by the at least two single cameras are the same moving object if the nodes representing the at least two common tracking identification numbers are recognized to be the same moving object.

2. The tracking system according to claim 1,
wherein, in the generated graph, a node representing the common tracking identification number and a node representing additional information about the same moving object to which the common tracking identification number is assigned are connected via at least one edge,
wherein, the additional information includes at least one of an image of the same moving object to which the common tracking identification number has been assigned, an appearance feature of the same moving object, an action of the same moving object, and a face image of a person if the same moving object is a person.

3. The tracking system according to claim 1,
wherein, in the processing to generate the graph, the processor is configured to:
determine whether the at least two moving bodies are the same moving object based on each feature quantity of the at least two moving bodies; and
when it is determined that the at least two moving bodies are the same moving object, link the common tracking identification number assigned to each of these moving bodies,
when the common tracking identification numbers respectively assigned to the at least two moving bodies are linked, in the generated graph, the nodes representing the common tracking identification number are connected via the at least one edge indicating that the at least two moving bodies are the same object.

4. The tracking system according to claim 1,
wherein, in the processing to generate the graph, the processor is configured to:
verify the determination based on each feature quantity of the at least two moving bodies; and
when it is determined that there is a discrepancy in the determination, the nodes representing the common tracking identification numbers assigned to the at least two moving bodies are disconnected from each other.

5. The tracking system according to claim 1,
wherein the processor is further configured to perform tracking processing of a tracking target by referring to the generated graph with a query as its input,
wherein, the query includes at least one of a date and time, a location, an image of the tracking target, and a face image of a person if the tracking target is a person.
